(19) United States
(12) Patent Application Publication
(10) Pub. No.: US 2025/0018686 A1
(43) Pub. Date: Jan. 16, 2025

(54) LAMINATED GLAZING WITH STEPPED BLOCKING ELEMENT

(71) Applicant: SAINT-GOBAIN GLASS FRANCE, COURBEVOIE (FR)

(72) Inventors: Jean-Benoit MAYEUX, SULLY (FR); Vincent RACHET, SULLY (FR)

(21) Appl. No.: 18/713,048

(22) PCT Filed: Nov. 16, 2022
(86) PCT No.: PCT/FR2022/052097

§ 371 Date: May 23, 2024

(30) Foreign Application Priority Data
Nov. 29, 2021 (FR) 2112662

(51) Int. Cl. B32B 17/10; B32B 3/26

(52) U.S. Cl. CPC B32B 17/10045; B32B 3/266; B32B 17/10302; B32B 17/10743; B32B 2307/7376; B32B 2605/18

(57) ABSTRACT

A laminated glazing includes a first exterior glass sheet and a second sheet, an adhesive layer, the edge of the sheet being set back with respect to that of the sheet, a portion of the free surface and the edge face of the sheet, 0 to 100% of the edge face of the layer and a portion of the surface of the sheet or of the layer, projecting beyond the sheet, describing a contour covered by an element, the glazing being attached to the structure by a window retainer, the element extending between the window retainer and the structure so as to constitute blocking of the element and of the glazing in the plane thereof; and the application of this glazing to an aeronautical clamped glazing.

This application relates to pinched glazings, subjected to pressure differentials between the two faces of the glazing, such as pressurized air vehicle glazings.

The periphery of the pinched (clamped) glazings is traditionally made by overmolding a seal (silicone), encapsulating all the constituents of the glazing.

This seal performs several functions, including sealing with the mounting structure, protection of the sheets (or folds) on the edge face, and moisture protection (prevention of delamination).

In the direction normal to the plane, the holding is ensured by the pinching of the seal between the window retainer (liner) and the mounting structure. In the plane, the translations are blocked in a single direction by the abutment of the glazing in the mounting structure. In the opposite direction, the rigidity of the windshield and the opposite stop ensure this function.

In known glazings, the seal assumes the entire physical contact function with the mounting structure and the window retainer; the seal thus constitutes an integral separation between the laminated glazing on the one hand, and the mounting structure and the window retainer on the other hand.

The functional requirements a pressurized aircraft glazing must meet include pressure resistance, which must be guaranteed not only when the glazing is intact (standard case) but also in the event of breakage of a structural element of the glazing (“fail safe”). “Structural element of the glazing” refers to a rigid sheet constituting the laminated glazing capable of forming a monolithic glazing itself, to ensure the mechanical strength thereof, in particular, and having an elastic modulus at least equal to 1500 MPa for example. These are sheets of mineral glass or transparent polymer material with a minimum thickness which of course varies according to their material. An adhesive interlayer entering the composition of a laminated glazing is, for example, never capable of having a minimum elastic modulus indicated above, sufficient mechanical strength, and cannot constitute a structural sheet or ply.

An additional requirement is sometimes added to this, referred to as the “double fail safe/full fail safe,” corresponding to the pressure resistance in the event of two or all structural elements of the glazing being broken.

The pinched assembly currently known in particular on medium and long commercial airplanes does not make it possible to meet this additional security requirement. Indeed, the breakage of the glass plies leads to the loss of rigidity which, associated with the opposite stop, would ensure that the windshield is held in position. The absence of holding in position associated with the pressure causes a significant deflection of the glazing which may go as far as removal (and therefore loss) thereof.

The purpose of the invention is to create a two-way connection (in the plane of the glazing and perpendicular thereto), independent of the structural plies (glass, etc.), between the mounting structure and the glazing (laminated). The glazing is thus held in place in its mounting environment, even in the event of breakage of one or more structural plies, and even of all of them. This aim is therefore achieved by the invention, which therefore relates to a laminated glazing comprising at least a first glass sheet and a second glass sheet bonded to one another by means of a first interlayer adhesive layer, the first glass sheet being intended to constitute the surface of the laminated glazing in contact with the outside atmosphere, wherein the edge of the first glass sheet is set back relative to that of the second, a peripheral portion of the free surface of the first glass sheet, the edge face of the latter, from 0 to 100% of the edge face of the first interlayer adhesive layer and a peripheral portion of the surface of the second glass sheet or of the first interlayer adhesive layer, projecting beyond the first glass sheet, describing a continuous stepped contour which is covered by a stepped element with interposition of glue, the laminated glazing being attached to the mounting structure by means of a window retainer which exerts a bearing force on said projection relative to the first glass sheet, which bearing force is exerted by means of the stepped element, characterized in that the stepped element extends to the contact surface between the window retainer and the structure, so as to constitute, in the mounting position of the laminated glazing, blocking of the stepped element and the laminated glazing in the plane thereof, and in that said blocking of the stepped element and of the laminated glazing in the plane thereof is carried out by cooperation of a shape of the stepped element with a complementary shape of the mounting structure and a complementary shape of the window retainer.

The shape of the stepped element, in particular its parts in contact with the peripheral portion of the free surface of the first glass sheet and with the protection of the laminated glazing relative to this first glass sheet, are able to block the laminated glazing in the direction perpendicular to its main plane. The parts of the stepped element that are in contact with the edge face of the first glass sheet and with 0 to 100% of the edge face of the first interlayer adhesive layer, and the extension of the stepped element between the window retainer and the structure, are able to block the laminated glazing in the direction of its main plane; a connection between the stepped element on the one hand, the window retainer and the mounting structure on the other hand, is carried out by said extension of the stepped element, as will be seen in more detail below.

The composition of the first and second glass sheets will be seen in detail below. Generally, the first glass sheet is a thin nonstructural protection sheet, that is, it does not provide the mechanical strength required for a monolithic glazing for example, and its main face internal to the laminated structure bears a network of wires or a thin layer such as Indium Tin Oxide (ITO), silver, gold or equivalent, which are electrically conducting and provide antifreeze/deicing. The second glass sheet is structural, often laminated on the side opposite the first glass sheet with one or more other structural sheets, so as together to form the structural block of the laminated glazing.

The stepped element, optionally called “Zed” when its profile is that of the letter z, constitutes a sealing barrier; it has the function of preventing any moisture from entering the laminated glazing. It is metallic (aluminum, stainless steel, etc.), made of polymer or composite material. Because the stepped element extends between the window retainer and the structure, it is possible owing to the invention to eliminate the injected seal which will be described in detail below, between the window retainer (liner) and the stepped element (“Zed”), since the latter guarantees a complete seal of the junction of the laminated glazing and of the mounting structure with respect to the outside atmosphere. This local elimination of the injected seal (elastomer, such as silicone) provides savings in the thickness of the assembly, and more precise positioning of the glazing (elimination of deformable material, in particular by compression-crushing).

In addition to the “full fail safe” function explained previously, the invention also provides simplified electrical continuity to the aircraft ground for an anti-static layer, resolution (elimination) of noisy electrostatic discharges, called “clicking noise,” which is a known source of bother for pilots, copilots, etc.

The cooperation of a shape of the stepped element with a complementary shape of the mounting structure and a complementary shape of the window retainer comprises for example an interlocking and/or a stop.

In a preferred embodiment, said blocking of the stepped element and of the laminated glazing in the plane thereof is carried out additionally by bolting the window retainer to the mounting structure through the stepped element having a through-hole for this purpose.

According to one variant of the invention, the stepped element covers a peripheral portion of the first interlayer adhesive layer projecting from the first glass sheet, and of thickness equal to part or all of the thickness of the first interlayer adhesive layer. In this case, the projection of the first interlayer adhesive layer relative to the first glass sheet may therefore relate to a fraction or the entire thickness of this layer.

Preferably, the laminated glazing comprises at least a third glass sheet that is linked to the second glass sheet by a second interlayer adhesive layer; as will be seen subsequently, the third glass sheet may be a structural sheet.

Preferably, the stepped element extends within the first and/or the second interlayer adhesive layer, so as to be integral therewith. This feature anchors the stepped element in the laminated structure, and participates in performing blocking, stopping of the laminated glazing in the direction of its main plane, by cooperating with the connection described above between the stepped element on the one hand, and the assembly of the mounting structure and the window retainer on the other hand, by complementary shapes and optionally bolting.

Preferably, the peripheral portion of the laminated glazing located between the face of the stepped element opposite the window retainer and the main face of the laminated glazing opposite the one formed by the first glass sheet, is covered by an air-and water-tight seal also protecting against solar radiation and fluids. It is a peripheral seal made of elastomeric polymer material, especially injectable or implemented by extrusion, such as silicone, polyurethane (PU), polysulfide elastomer. The contiguous contact of the seal and the stepped element is completely airtight and watertight.

Preferably, the stepped element is covered by a bead which provides the laminated glazing with aerodynamic continuity between glazing and mounting structure such as an airplane structure and good inertia to the treatment fluids such as aeronautical fluids, cleaning products, degreasing agent, glycol for deicing on the ground and the like.

Preferably, the first glass sheet is made of a mineral glass with a thickness of between 0.5 and 5, preferably between 2 and 4 mm, or made of a polymer material such as poly (methyl methacrylate) (PMMA) with a thickness of between 0.5 and 5 mm. It is a nonstructural protection sheet for protecting the underlying structural block. A mineral glass here refers to a soda-lime, aluminosilicate, borosilicate glass, optionally hardened, thermally tempered, or chemically strengthened. Transparent polymer materials other than PMMA can be used, in particular polycarbonate (PC), polyethylene terephthalate (PET) or polyurethane (PU). When the first glass sheet is made of a polymer material such as PC, its free surface is advantageously provided with an anti-scratch coating or varnish of the polysiloxane, hydrophilic, hydrophobic, etc. type

Preferably, the second glass sheet and, if applicable, the third glass sheet and so on are made of a mineral glass with a thickness of between 4 and 10 mm, or made of a polymer material such as poly (methyl methacrylate) (PMMA) with a thickness of between 5 and 30, preferably at most 20 mm. These are structural sheets or structural plies.

Preferably, the interlayer adhesive layers are made of thermoplastic polyurethane (TPU), polyvinyl butyral (PVB), ethylene/vinyl acetate (EVA) copolymer, ionomer resin, cast resin, the thickness of the first interlayer adhesive layer is between 3 and 10, preferably 4 and 8 mm, and the thickness of the second interlayer adhesive layer and, if applicable, of the following layers is between 0.5 and 4, preferably at most equal to 2 mm.

Another object of the invention consists in applying a laminated glazing as described above to a pinched glazing, of the aeronautical type (cockpit and window) for pressurized or non-pressurized, fixed or rotary wing aircraft, railway, armored vehicle, or boat (wheelhouse, window) type. Mention is made of a cockpit glazing for a long-haul commercial aircraft or for a medium-haul mail aircraft.

The invention will be better understood in light of the description of the appended drawings, wherein:

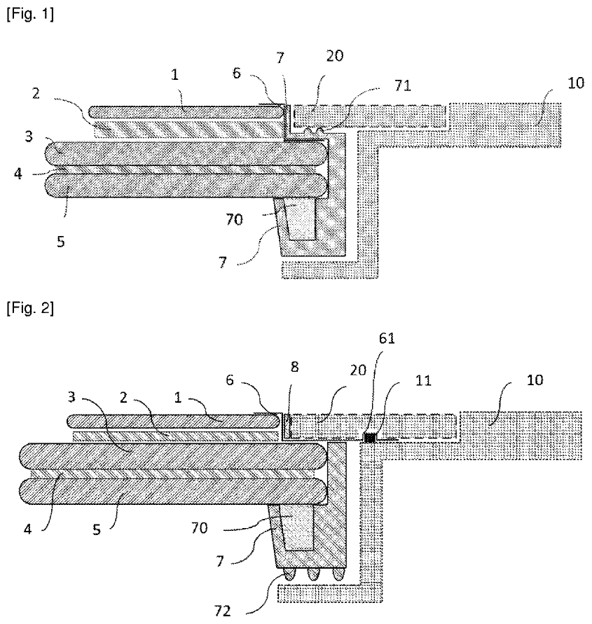

FIG. 1 is a schematic cross-sectional depiction of an example of a laminated glazing mounted by pinching in a commercial aircraft cockpit opening, known at the time of the implementation of the present invention;

FIG. 2 schematically depicts, in cross section, a first variant of the laminated glazing of the invention;

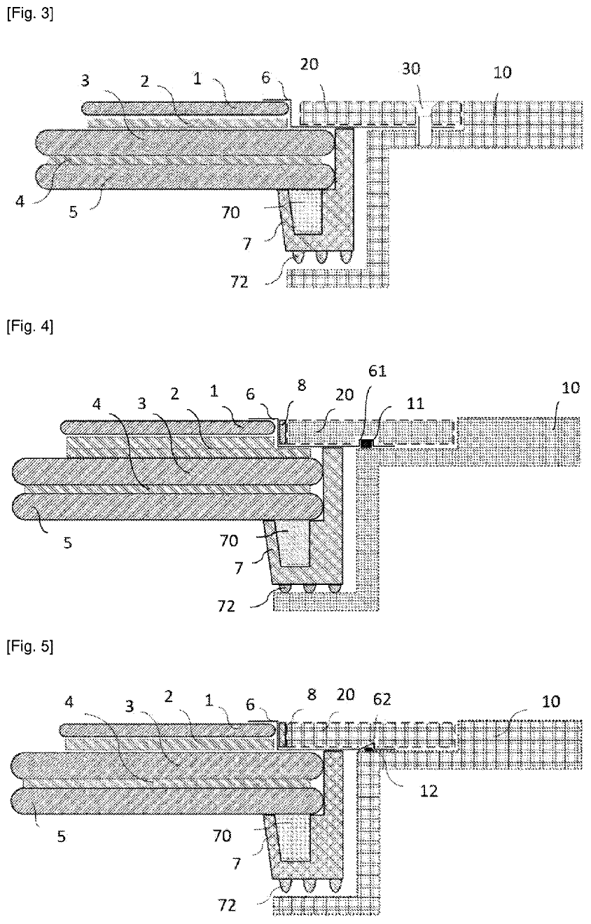

FIG. 3 schematically depicts, in cross section, only the bolting of the window retainer to the mounting structure through the stepped element;

FIG. 4 schematically depicts, in cross section, a second variant of the laminated glazing of the invention;

FIG. 5 schematically depicts, in cross section, a third variant of the laminated glazing of the invention;

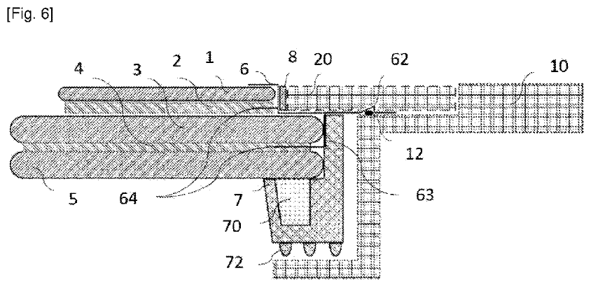

FIG. 6 schematically depicts, in cross section, a fourth variant of the laminated glazing of the invention.

With reference to FIG. 1, a laminated glazing of the prior art comprises a first glass sheet 1 forming an exterior face of the glazing, having a thickness of 3 mm, which is bonded to a second glass sheet 3 having a thickness of 8 mm by a first polyurethane (PU) interlayer adhesive layer 2 having a thickness of 5.76 mm.

A third glass sheet 5 having a thickness of 8 mm is bonded to the second 3 by a second polyvinyl butyral (PVB) interlayer adhesive layer 4 having a thickness of 2 mm.

The edge faces of the second and third glass sheets 3, 5 are optionally protected from impacts by relatively hard elastomer sheets, not shown.

The edge of the first glass sheet 1 is set back with respect to that of the second 3, a peripheral portion of the free surface of the first glass sheet 1, the edge face of this glass sheet 1, the edge face of the first interlayer adhesive layer 2 and a portion of the surface of the second glass sheet 3 extending beyond the first glass sheet 1 describing a stepped continuous contour which is covered by a stepped element 6 made of a conductive metal. The stepped metal element 6 is grounded.

Said stepped continuous contour is covered by the stepped element 6 with interposition of a thickness of 100 μm of glue made of polysulfide, not shown.

The stepped element 6 is covered by an air-and water-tight seal 7, made of silicone, and if applicable by a bead made of polysulfide, not shown, which provides the laminated glazing with aerodynamic continuity between the glazing and the mounting structure such as an airplane structure, and good inertia to treatment fluids such as aeronautical fluids, cleaning products, degreasing agents, glycol for deicing on the ground and the like.

The exterior surface of the silicone seal 7 has sealing lips 71. In addition, in the lower part of the silicone seal 7, a thickness spacer 70 (or stiffening) made from a harder material than the silicone is inserted so as to guarantee that the laminated glazing is indeed held in its mounting position, by exerting a certain pressure, such as by pinching. The thickness spacer 70 is solid, but may comprise recesses.

The face of the glass sheet 1 oriented toward the interior of the laminated structure bears a heating layer, consisting of indium tin oxide (ITO) or an equivalent such as gold, silver multilayer, ZnO:Al, SnO₂:F, etc. The heating layer is effective to deice the exterior surface of the glass sheet 1.

The laminated glazing is attached to the fuselage 10 of the commercial aircraft by means of a window retainer 20 (or liner) bolted to the fuselage 10, and which exerts a bearing force on the projection of the second glass sheet 3 relative to the first 1, which bearing force is exerted by means of the stepped element 6 and the silicone seal 7, in particular, the lips 71 of which ensure the sealing between the liner 20 and the silicone seal 7.

Referring to FIG. 2, the stepped element 6 extends to the contact surface between the window retainer 20 and the mounting structure 10. The stepped element 6 has a rectangular profile 61 able to interlock in the complementary profile 11 presented by the structure 10, and a complementary profile presented by the window retainer 20. The latter 20 is bonded or bolted to the aircraft structure 10. In this configuration, the laminated glazing has a “full fail safe” function: in the event of breakage of the two structural plies 3 and 5, the mounting system described is capable of holding the glazing in place in its opening.

Moreover, the stepped element 6 provides complete air-and water-tightness, making it possible to eliminate the silicone seal 7 between the stepped element 6 and the window retainer 20. The mounting structure is thus thinned and lightened, and the positioning of the laminated glazing is more precise.

The silicone seal 7 has sealing lips 72 opposite the mounting structure 10.

A filler seal 8 made from two-component polysulfide sealant is interposed between the window retainer 20 (or window clamp) and the stepped element 6 (Zed). This seal (8) is able to provide aerodynamic continuity.

Referring to FIG. 3, the window retainer 20 is bolted to the mounting structure 10 through the stepped element 6, which is provided for this purpose with a through-hole.

Referring to FIG. 4, only part of the thickness of the first interlayer adhesive layer 2 projects from the first glass sheet 1. The stepped element 6 is in contiguous contact with this projection of the first interlayer adhesive layer 2.

Referring to FIG. 5, the stepped element 6 has a triangular profile 62 complementary to a triangular profile 12 of the mounting structure and a triangular profile of the window retainer 20.

Referring to FIG. 6, the stepped element extends 63 by covering the edge face of the second glass sheet 3, and within the first interlayer adhesive layer 2 and the second interlayer adhesive layer 4, at anchors 64.

1. A laminated glazing comprising:
at least a first glass sheet and a second glass sheet bonded to one another by means of a first interlayer adhesive layer,
the first glass sheet being intended to constitute a surface of the laminated glazing in contact with the outside atmosphere,
wherein an edge of the first glass sheet is set back relative to that of the second glass sheet, a peripheral portion of a free surface of the first glass sheet, the edge face of the first glass sheet, from 0 to 100% of a edge face of the first interlayer adhesive layer and a peripheral portion of the surface of the second glass sheet or of the first interlayer adhesive layer, projecting beyond the first glass sheet, describing a stepped continuous contour which is covered by a stepped element with interposition of glue,
the laminated glazing being attached to a mounting structure by a window retainer which exerts a bearing force on said projection relative to the first glass sheet, which bearing force is exerted by the stepped element,
wherein the stepped element extends to the contact surface between the window retainer and the structure, so as to constitute, in the mounting position of the laminated glazing, blocking of the stepped element and the laminated glazing in a plane thereof, and
wherein said blocking of the stepped element and of the laminated glazing in the plane thereof is carried out by cooperation of a shape of the stepped element with a complementary shape of the mounting structure and a complementary shape of the window retainer.

2. The laminated glazing according to claim 1, wherein said blocking of the stepped element and of the laminated glazing in the plane thereof is carried out by bolting the window retainer to the mounting structure through the stepped element having a through-hole.

3. The laminated glazing according to claim 1, wherein the stepped element covers a peripheral portion of the first interlayer adhesive layer projecting from the first glass sheet, and of thickness equal to part or all of a thickness of the first interlayer adhesive layer.

4. The laminated glazing according to claim 1, further comprising at least one third glass sheet connected to the second glass sheet by a second adhesive interlayer.

5. The laminated glazing according to claim 4, wherein the stepped element extends within the first and/or the second interlayer adhesive layer, so as to be integral therewith.

6. The laminated glazing according to claim 1, wherein the peripheral portion of the laminated glazing located between the face of the stepped element opposite the window retainer and the main face of the laminated glazing opposite the one formed by the first glass sheet, is covered by an air- and water-tight seal also protecting against solar radiation and fluids.

7. The laminated glazing according to claim 1, wherein the first glass sheet is made of mineral glass having a thickness of between 0.5 and 5 mm or is made of a polymer material having a thickness of between 0.5 and 5 mm.

8. The laminated glazing according to claim 4, wherein the second glass sheet and, optionally, the third glass sheet are made of mineral glass having a thickness of between 4 and 10 mm, or are made of a polymer material having a thickness of between 5 and 30.

9. The laminated glazing according to claim 4, wherein the adhesive interlayers are made of thermoplastic polyurethane (TPU), polyvinyl butyral (PVB), ethylene-vinyl acetate (EVA) copolymer, ionomer resin, cast resin, wherein a thickness of the first adhesive interlayer is between 3 and 10 mm and wherein a thickness of the second adhesive interlayer and, optionally, of subsequent layers, is between 0.5 and 4 mm.

10. A method comprising providing a laminated glazing according to claim 1 to a pinched glazing of the aeronautical type for pressurized or non-pressurized, fixed or rotary wing aircraft, railway, armored vehicle, or boat type.

11. The laminated glazing according to claim 7, wherein the thickness of the first glass sheet is between 2 and 4 mm, or the polymer material is poly(methyl methacrylate) (PMMA).

12. The laminated glazing according to claim 8, wherein the polymer material is poly(methyl methacrylate) (PMMA).

13. The laminated glazing according to claim 8, wherein the thickness of the polymer material is at most 20 mm.

14. The laminated glazing according to claim 9, wherein the thickness of the first adhesive interlayer is between 4 and 8 mm.

15. The laminated glazing according to claim 9, wherein the thickness of the first adhesive interlayer is at most equal to 2 mm.

16. The method according to claim 10, wherein the laminated glazing is a cockpit or window.
